(19) United States
(12) Patent Application Publication
(10) Pub. No.: US 2006/0075895 A1
(43) Pub. Date: Apr. 13, 2006

(54) Processing method of exhaust gas and processing apparatus of exhaust gas

(76) Inventors: Takashi Shimada, Kanagawa (JP); Noboru Takemasa, Kanagawa (JP); Koshi Ochi, Kanagawa (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/244,239

(22) Filed: Oct. 6, 2005

(30) Foreign Application Priority Data
Oct. 7, 2004 (JP) 2004-294511

(51) Int. Cl. B01D 53/14; B01D 53/68

(52) U.S. Cl. 95/233; 423/240 R

(57) ABSTRACT

A processing method of an exhaust gas which comprises a step (A) adding a halogen-based gas-absorbing liquid to an adsorbent and a step (B) bringing the exhaust gas containing a halogen-based gas discharged from semiconductor manufacturing facilities into contact with the adsorbent, to remove the halide-based gas from the exhaust gas. A processing apparatus of an exhaust gas, which comprises an inlet for the exhaust gas containing a halogen-based gas discharged from semiconductor manufacturing facilities, a filling part of an adsorbent, means for adding a halogen-based gas-absorbing liquid to the filling part and an outlet of the processed gas. A processing method and a processing apparatus both for an exhaust gas containing the halogen-based gas discharged from semiconductor manufacturing facilities without requiring to frequently replace a cleaning agent with a new one, without jeopardy of causing fire even when processing a dry exhaust gas containing a highly reactive gas, and capable of easily reducing a concentration of the halogen-based gas among the gas after being processed is provided.

### TECHNICAL FIELD

The present invention relates to a processing method of an exhaust gas and a processing apparatus of an exhaust gas. Particularly, the present invention relates to a processing method of the exhaust gas and a processing apparatus of the exhaust gas both efficiently remove a halogen-based gas from the exhaust gas containing the halogen-based gas discharged from semiconductor manufacturing facilities.

### BACKGROUND ART

In the field of semiconductor, a halogen-based gas such as halogen, hydrogen halide or so is conventionally employed in versatile as an etching gas or a cleaning gas. However, the halogen-based gas is harmful to human body and environment, and accordingly, the exhaust gas containing these gasses are necessarily cleaned before being discharged from factories. As a cleaning process for an exhaust gas containing the halogen-based gas, a dry cleaning process in which the exhaust gas is introduced into a processing column filled with solid cleaning agents and is brought into contact with the cleaning agents for a purpose of removing the halogen-based gas from the exhaust gas, or a wet cleaning process in which the exhaust gas is brought into contact with the halogen-based gas-absorbing liquid spouting out from upper part of a processing apparatus for a purpose of removing the halogen-based gas from the exhaust gas is frequently adopted.

As the cleaning agent conventionally employed for the dry cleaning process, Japanese Unexamined Patent Application Laid-Open No. Hei 9-234337 discloses a cleaning agent made by adhering sodium formate onto metal oxides containing copper oxide and manganese oxide as main components, Japanese Unexamined Patent Application Laid-Open No. Hei 9-267027 discloses a cleaning agent comprising a manganese oxide, a potassium hydroxide and an alkaline earth metal hydroxide as three main components, and Japanese Unexamined Patent Application Laid-Open No. 2000-157836 discloses a cleaning agent made by adhering alkali metal salt of formic acid and/or alkaline earth metal salt of formic acid onto activated carbon.

On the other hand, regarding with a halogen-based gas-absorbing liquid employed for the wet cleaning process, Japanese Unexamined Patent Application Laid-Open No. Shou 49-62378 discloses an aqueous solution comprising sulfurous acid alkali salt or acidic sulfurous acid alkali salt. Further, an aqueous solution comprising sodium hydroxide and so on as a chemical agent is also known as the halogen-based gas-absorbing liquid.

However, while the dry cleaning process is capable of removing the halogen-based gas down to extremely low concentration, in the case where it processes large volume of the exhaust gas containing the halogen-based gas of high concentration, it has a disadvantage of paying an expensive running cost because it is necessary to frequently replace the cleaning agent which causes breakthrough in a short time with a new one. Further, in a case where a dry exhaust gas containing a highly reactive gas such as fluorine gas is processed employing activated carbon as the cleaning agent, there was jeopardy of causing fire.

While the wet cleaning process is suitable for processing large volume of the exhaust gas containing the halogen-based gas of high concentration, a removing efficiency of halogen-based gas, particularly chloride gas, is comparatively low. Accordingly, it was necessary to increase a concentration of a chemical agent such as sodium hydroxide in a chemical solution or to considerably extend a time for contacting the exhaust gas with water in order to sufficiently reduce the concentration of the halogen-based gas among a gas after processing. Further, when the concentration of the chemical agent in the chemical solution is increased, there comes a disadvantage that a running cost of the chemical agent soars. Moreover, when the time for contacting the exhaust gas with water is extended, there comes a disadvantage that a processing apparatus is large-sized or complexes. Furthermore, in any cases, there comes a disadvantage of troublesome in maintenance.

### DISCLOSURE OF THE INVENTION

Therefore, an object of the present invention is to provide a processing method and a processing apparatus both for an exhaust gas containing the halogen-based gas discharged from semiconductor manufacturing facilities without requiring to frequently replace a cleaning agent with a new one, without jeopardy of causing fire even when processing a dry exhaust gas containing a highly reactive gas, and capable of easily reducing a concentration of the halogen-based gas among the gas after being processed.

As a result of intensive extensive research and investigation made by the present inventors in order to achieve the object, it has been found that a removal of the halogen-based gas with adsorption from the exhaust gas by bringing the exhaust gas containing the halogen-based gas discharged from semiconductor manufacturing facilities into contact with an adsorbent together with adding halogen-based gas-absorbing liquid to the adsorbent, thereby desorbing the halogen-based gas adsorbed to the adsorbent by being absorbed to the halogen-based gas-absorbing liquid is very effective. Namely, the above procedure was found to be effective in processing the exhaust gas without requiring to replace the adsorbent (cleaning agent) with a new one or without jeopardy of causing fire, and to be capable of easily reducing a concentration of the halogen-based gas among the gas after being processed. Such being the case, the present invention has been accomplished on the basis of the foregoing findings and information.

Namely, the present invention provides a processing method of an exhaust gas which comprises a step (A) adding a halogen-based gas-absorbing liquid to an adsorbent and a step (B) bringing the exhaust gas containing a halogen-based gas discharged from semiconductor manufacturing facilities into contact with the adsorbent, to remove the halogen-based gas from the exhaust gas. In other words, the present invention provides a processing method of an exhaust gas bringing the exhaust gas containing the halogen-based gas discharged from semiconductor manufacturing facilities into contact with an adsorbent together with adding halogen-based gas-absorbing liquid to the adsorbent, thereby removing the halogen-based gas from the exhaust gas.

Further, the present invention provides a processing apparatus of an exhaust gas, which at least comprises an inlet for the exhaust gas containing a halogen-based gas discharged from semiconductor manufacturing facilities, a filling part of an adsorbent, means for adding a halogen-based gas-absorbing liquid to the filling part and an outlet of the processed gas.

### BRIEF DESCRIPTION OF THE DRAWINGS

FIG. 1 is a vertical cross-sectional view showing an embodiment of a processing apparatus of exhaust gas of the present invention;

FIG. 2 is a vertical cross-sectional view showing another embodiment of a processing apparatus of exhaust gas of the present invention aside from FIG. 1: and

FIG. 3 is a vertical cross-sectional view showing an embodiment of a processing apparatus of exhaust gas of the present invention aside from FIGS. 1 and 2.

### THE PREFERRED EMBODIMENT TO CARRY OUT THE INVENTION

The processing method of the exhaust gas and the processing apparatus of the exhaust gas in accordance with the present invention are applied to both a processing method and a processing apparatus for removing the halogen-based gas from the exhaust gas containing the halogen-based gas discharged from semiconductor manufacturing facilities.

In the present invention, examples of the halogen-based gas include a halogen gas such as a chlorine gas, a bromine gas or an iodine gas; a hydrogen halide gas such as a hydrogen fluoride gas, a hydrogen chloride gas, a hydrogen bromide gas or a hydrogen iodide gas; a boron halide gas such as a boron trifluoride gas or a boron trichloride gas; a silicon halide gas such as a silicon tetrafluoride gas or a silicon tetrachloride gas; a tungsten halide gas such as a tungsten hexafluoride gas; and further include a chlorine trifluoride gas, a titanium tetrachloride gas, an aluminum chloride gas, a germanium tetrafluoride gas, etc.

Typical examples of the adsorbent employable in the present invention include an activated carbon, a zeolite and a porous ceramic, and among these, employing the activated carbon is preferable in a viewpoint capable of removing the halogen-based gas with high removing efficiency. In the case where the activated carbon is employed as the adsorbent, a palmhusk charcoal, a slack charcoal, a peat charcoal or so is employable without particularly specifying the kind of the activated carbon. Further, granular charcoals with diameters of around 1 to 10 mm, pellet-type charcoals with diameters of around 1 to 5 mm and with lengths of around 3 to 30 mm or fibrous charcoals may be employable without particularly specifying the shapes of the activated carbon.

In the case where the zeolite is employed as the adsorbent, any of a synthetic zeolite and a natural zeolite may be adopted. Any kind of the zeolite may be employable without being particularly specified and, for example, any commercially available synthetic zeolite with pore diameters of 3 to 15 Å equivalent in the market may be employable. Furthermore, in the case where the porous ceramics are employed as the adsorbent, alumina, silica alumina or so may be adopted. With regards to the specific surface of the adsorbents, its value is usually 100 to 3000 m²/g, preferably 500 to 3000 m²/g about activated carbons, and is usually 50 to 500 m²/g about zeolite or porous ceramics. In the present invention, the adsorbents may be employed in combination or in lamination of two or more kinds of themselves.

Further in the present invention, the halogen-based gas-absorbing liquid means water or a chemical solution and when the chemical solution is employed, the present invention is not limited to the kind or so of the chemical solution. However, the chemical solution comprising alkaline aqueous solution, aqueous solution containing salt of alkali metal compound, or aqueous solution containing salt of alkaline earth metal, and aqueous solution of such as alkali metal hydroxide of sodium hydroxide, alkaline earth metal hydroxide of calcium hydroxide, sodium sulfite, sodium thiosulfate, sodium carbonate or sodium hydrogen carbonate may be employable. Because the present invention provides a processing method of an exhaust gas bringing the exhaust gas containing the halogen-based gas into contact with an adsorbent together with adding halogen-based gas-absorbing liquid to the adsorbent, thereby removing the halogen-based gas from the exhaust gas, a removing efficiency of the halogen-based gas can be elevated, and therefore the concentration of the hydroxide in the chemical solution can be reduced remarkably. In an occasion of carrying out the present invention, although water is usually employed as the halogen-based gas-absorbing liquid, when the above chemical solution is employed as the halogen-based gas-absorbing liquid, a total concentration of the compound in the chemical solution is up to 40% by weight.

Moreover, the processing method of the exhaust gas which further comprises a step (C) bringing the exhaust gas containing the halogen-based gas into contact with the halogen-based gas-absorbing liquid under the existence of a filler incapable of adsorption enables to enhance the removing efficiency of the halogen-based gas still excitingly.

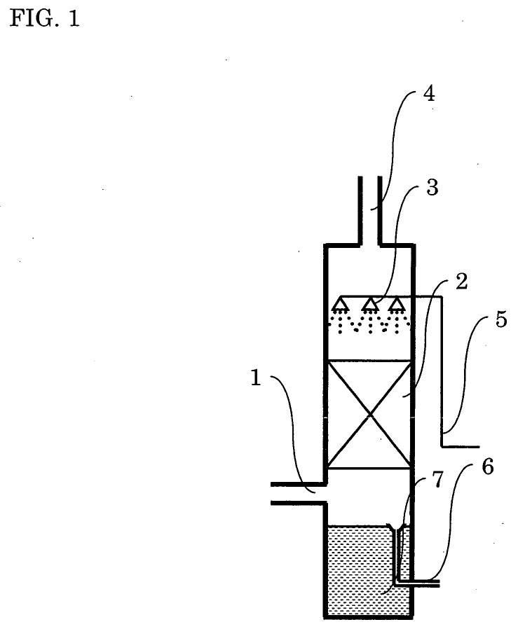

The processing method of an exhaust gas and the processing apparatus in the present invention will be described in further detail with reference to FIGS. 1 to 3, which does not limit the scope of the invention.

FIGS. 1 to 3 are vertical cross-sectional views each showing embodiments of the processing apparatus of exhaust gas in the present invention.

As shown in FIG. 1, a processing apparatus of exhaust gas in accordance with the present invention comprises an inlet 1 for the exhaust gas containing the halogen-based gas and discharged from semiconductor manufacturing facilities, a filling part 2 of the adsorbent, means 3 (for example, a spray nozzle or a shower head nozzle) for adding the halogen-based gas-absorbing liquid and outlet 4 of the processed gas. Usually, the processing apparatus of exhaust gas in accordance with the present invention further comprises feed pipe 5 for supplying the halogen-based gas-absorbing liquid, drain pipe 6 and reservoir 7 for the halogen-based gas-absorbing liquid.

The processing method of exhaust gas in accordance with the present invention is carried out by introducing the exhaust gas containing the halogen-based gas discharged from semiconductor manufacturing facilities into above processor apparatus and bringing the exhaust gas into contact with the adsorbent, together with adding the halogen-based gas-absorbing liquid to the adsorbent. The step of adding the halogen-based gas-absorbing liquid to the adsorbent may be conducted at least one selected from before, after or at a timing of the step of processing the exhaust gas containing the halogen-based gas. In the present invention, when the exhaust gas containing the halogen-based gas comes into contact with the adsorbent, the halogen-based gas is adsorbed by the adsorbent. Further, when the halogen-based gas-absorbing liquid is added to the adsorbent, the halogen-based gas adsorbed to the adsorbent will be desorbed from the adsorbent because the halogen-based gas will be absorbed to the halogen-based gas-absorbing liquid. The halogen-based gas is also adsorbed to the adsorbent even under the existence of the halogen-based gas-absorbing liquid.

In the present invention, it is considered that the usage of the adsorbent having large specific surface promotes the halogen-based gas being adsorbed to the adsorbent to contact with and to adsorb to the halogen-based gas-absorbing liquid favorably, and as a result, removal of the halogen-based gas from the exhaust gas is efficiently conducted. Particularly, the present invention enables to remove chlorine gas, which is difficult to remove among the halogen-based gas, with high removing efficiency. Having the foregoing constitution, the processing method of exhaust gas in accordance with the present invention also enables to use the adsorbent for an extremely long time without requiring to frequently replace the adsorbent (i.e., cleaning agent) with a new one. Further, even when processing a dry exhaust gas containing a highly reactive gas such as fluorine gas, jeopardy of causing fire may be evadable by conducting addition of the halogen-based gas-absorbing liquid before processing the exhaust gas.

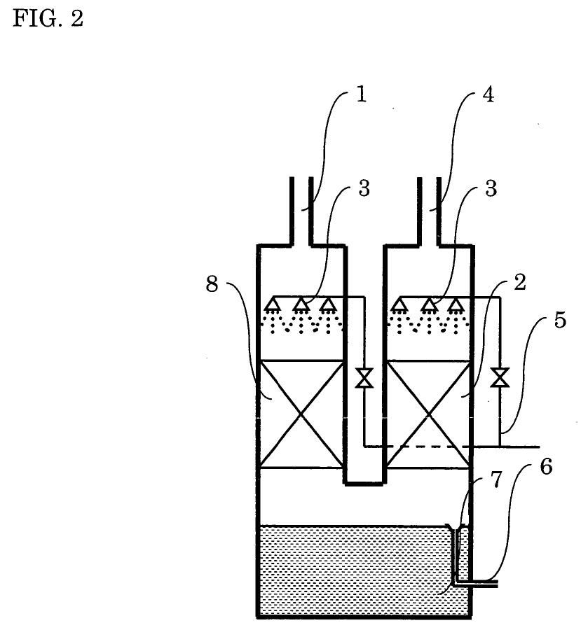

In the case where the exhaust gas discharged from semiconductor manufacturing facilities contains chlorine gas that are difficult to remove and other halogen-based gas, it is preferable to employ the processing apparatus as shown in FIG. 2 further comprising a filling part 8 of a filler incapable of adsorption at a passage way of the exhaust gas between inlet 1 for the exhaust gas containing the halogen-based gas and filling part 2 of the adsorbent, and still further comprising means 3 for adding the halogen-based gas-absorbing liquid to the filling part 8 of the filler incapable of adsorption. Having the foregoing constitution, the processing apparatus of exhaust gas in accordance with the present invention enables to preparedly remove the halogen-based gas except chlorine gas such as fluorine gas with high reactivity, both hydrogen fluoride gas and hydrogen chloride gas that have high solubility to water by bringing the exhaust gas into contact with the filler incapable of adsorption and with the halogen-based gas-absorbing liquid, and to reduce the load of adsorbent 2, resultantly enables to remove chlorine gas from the exhaust gas with enhanced removing efficiency. Additionally, the filler incapable of adsorption is defined as a filler with specific surface of usually up to 1 m²/g, and examples include resinous fillers such as polyvinylchloride.

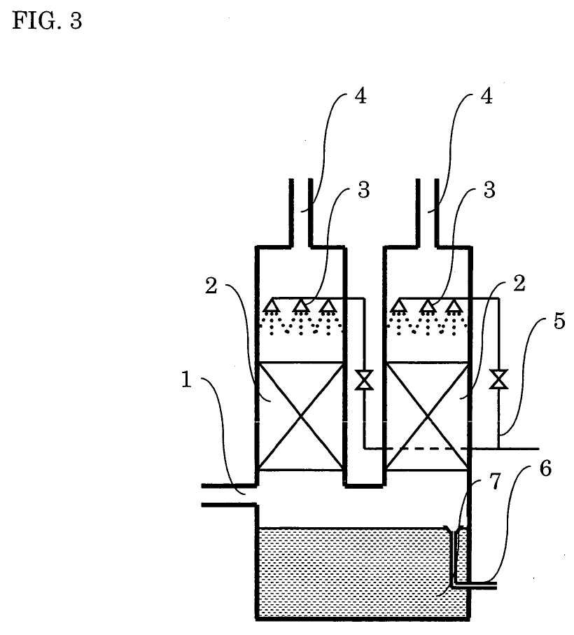

Further in the present invention, a processing apparatus of exhaust gas equipped with two or more means 3 for adding the halogen-based gas-absorbing liquid in parallel over filling part 2 of the adsorbent as shown in the FIG. 3 may be practically used. Having the foregoing constitution, the processing apparatus of exhaust gas in accordance with the present invention enables to reactivate the adsorbent because it adsorbs the exhaust gas containing the halogen-based gas without adding the halogen-based gas-absorbing liquid in one of the filling parts of adsorbent, simultaneously desorbs the halogen-based gas by adding the halogen-based gas-absorbing liquid without feeding the exhaust gas containing the halogen-based gas in the other one of the filling parts of adsorbent in parallel.

In the present invention, regarding with an addition amount of the halogen-based gas-absorbing liquid to the adsorbent or to the filler incapable of adsorption, it is not generally specified. However, the flow rate of the halogen-based gas-absorbing liquid in the case where the halogen-based gas is simultaneously adsorbed is 0.01 to 2 liter/minute per 1 liter of the adsorbent or the filler incapable of adsorption, and the flow rate of the halogen-based gas-absorbing liquid in the case where the halogen-based gas is not simultaneously is 0.01 to 5 liter/minute per 1 liter of the adsorbent or the filler incapable of adsorption.

In the present invention, the exhaust gas consists of an inert gas such as helium gas, nitrogen gas or argon gas as a base gas and contains the halogen-based gas in an amount of around 100 to 100,000 ppm. With regard to the temperature and the pressure of the exhaust gas being processed in the present invention, although they are not particularly specified, the temperature is usually room temperature or the adjacent temperature (around 0 to 100° C.), and the pressure is usually an atmospheric pressure. The pressure may be a reduced pressure of 10 KPa (absolute pressure) or pressurized such as 1 MPa (absolute pressure). Moreover, although the temperature of the halogen-based gas-absorbing liquid is also not particularly specified, it is usually room temperature or the adjacent temperature (around 0 to 100° C.). Additionally, a combination with a dry cleaning method as a post-process of the processing method of the present invention enables to remove the halogen-based gas to extremely low concentration together with to remarkably extend a service life of a cleaning agent in a dry cleaning apparatus.

### EXAMPLES

In the following examples are described several preferred embodiments to concretely illustrate the invention; however, it is to be understood that the invention is not intended to be limited to the specific embodiments.

### Example 1

(Preparation of Processing Apparatus)

A processing apparatus comprising an inlet for the exhaust gas, a filling part of the adsorbent, a spray nozzle, an outlet of the processed gas and a reservoir for the halogen-based gas-absorbing liquid as shown in FIG. 1 was prepared by filling 4 liter of commercially available pellet-shaped activated carbon (specific surface: 1400 m²/g; diameter: 4 mm; length: 5 mm) into a cylindrical processing column made of polyvinylchloride having an inside diameter of 110 mm and a height of 800 mm, further connecting a feed pipe of halogen-based gas-absorbing liquid and a drain pipe.

(Processing Test of Exhaust Gas)

The activated carbon was washed by adding water to the adsorbent from the above spray nozzle in the processing apparatus with a flow rate of 2.4 litter/minute for 60 minutes. After discontinuing the addition of water, chlorine molecules were adsorbed and removed from the exhaust gas for 4 hours by introducing a gas consisting of nitrogen gas as a base gas and containing chlorine gas in an amount of 10,000 ppm into the processing apparatus with a flow rate of 7.5 liter/minute. Meanwhile, sampling the processed gas every 10 minutes, concentrations of chlorine gas were measured by means of a detector tube produced by Gastec Corporation. Subsequently, discontinuing the introduction of the gas, the chlorine molecules were desorbed from the adsorbent by washing the activated carbon with adding water to the adsorbent from the above spray nozzle again with a flow rate of 2.4 liter/minute for 60 minutes. Afterwards, the chlorine molecules were adsorbed and removed from the exhaust gas for 4 hours in the same manner as the above description. Further, the operation was repeated and the processing tests were totally carried out 20 times. The results are shown in Table 1. Additionally, all of “removing efficiency” in Tables below indicates averaged values.

### Examples 2 and 3

Processing tests of exhaust gas were carried out in similar manners as Example 1 except that the concentration of the chlorine gas was changed to 1,000 ppm or 20,000 ppm respectively. The results are shown in Table 1.

### Examples 4 to 8

Processing tests of exhaust gas were carried out in similar manners as Example 1 except that the halogen-based gas was replaced to fluorine gas, hydrogen chloride gas, boron trichloride gas, dichlorosilane gas and tungsten hexafluoride gas respectively. The results are shown in Table 1.

### Examples 9 and 10

Processing tests of exhaust gas were carried out in similar manners as Example 1 except that the adsorbent was replaced to commercially available spherical activated alumina (specific surface: 320 m²/g, diameter: 5 mm) or commercially available granular synthetic zeolite (pore diameter: 5 Å equivalent) respectively. The results are shown in Table 1.

### Example 11

Processing test of exhaust gas was carried out in similar manners as Example 1 except that the activated carbon was washed only once at the first time and that water was added to the adsorbent at the flow rate of 1.2 litter/minute also when the exhaust gas was introduced and brought into contact with the adsorbent. The results are shown in Table 1. Additionally, the processing tests were carried out continuously for 80 hours while determining the averaged value of the removing efficiency every 4 hours.

### Example 12

(Preparation of Processing Apparatus)

A processing apparatus as shown in FIG. 2 consisting of two cylindrical processing columns made of polyvinylchloride each having inside diameter of 110 mm and height of 800 mm in the same manner as Example 1 was prepared by filling 4 liter of commercially available polyvinylchloride Raschig ring (specific surface: 200 m²/m³ (0.028 m²/g), diameter: 25 mm, length: 30 mm) into an upstream side processing column, filling 4 liter of activated carbon into a downstream side column, and connecting feed pipes of halogen-based gas-absorbing liquid and drain pipes. The upstream side and the downstream side are defined concerning the flowing direction of the exhaust gas.

(Processing Test of Exhaust Gas)

The activated carbon and the polyvinylchloride were washed by adding water to the adsorbent and the cleaning agent from each spray nozzle in the processing apparatus with flow rate of 2.4 liter/minute for 60 minutes. After discontinuing the addition of water only to the downstream side processing column, chlorine molecules and hydrogen chloride molecules were adsorbed and removed from the exhaust gas for 4 hours by introducing a gas consisting of nitrogen gas as a base gas and containing chlorine gas in an amount of 10,000 ppm and hydrogen chloride gas in an amount of 10,000 ppm into the processing apparatus with a flow rate of 7.5 liter/minute. Meanwhile, sampling the processed gas after passing the upstream side processing column and after passing the downstream side processing column respectively every 10 minutes, concentrations of chlorine gas and hydrogen chloride gas were measured by means of a detector tube produced by Gastec Corporation. The results are shown in Table 2. Additionally, removing efficiency in the downstream side means the total removing efficiency.

### Comparative Example 1

Processing test of exhaust gas was carried out only once in a similar manner as Example 1 except that the adsorbent was replaced to commercially available polyvinylchloride Raschig ring (specific surface: 200 m²/m³ (0.028 m²/g), diameter: 25 mm, length: 30 mm). The results are shown in Table 1.

### Comparative Example 2

Processing test of exhaust gas was carried out only once in a similar manner as Example 1 except that the adsorbent was replaced to commercially available polyvinylchloride Raschig ring (specific surface: 200 m²/m³ (0.028 m²/g), diameter: 25 mm, length: 30 mm) and further adding water to the adsorbent with a flow rate of 1.2 liter/minute from the spray nozzle even when the exhaust gas was introduced and brought into contact with the adsorbent. The results are shown in Table 1.

### Comparative Example 3

Processing test of exhaust gas was carried out in a similar manner as Example 12 except that the adsorbent was replaced to commercially available polyvinylchloride Raschig ring (specific surface: 200 m²/m³ (0.028 m²/g), diameter: 25 mm, length: 30 mm). The results are shown in Table 2.

TABLE 1

| | Halogen- | Concen- | | |
|---|---|---|---|---|
| | based | tration | | Timing of |
| | gas | (ppm) | Filler | Water Addition |
| Example 1 | Chlorine | 10,000 | Activated | Not contacting |
| | | | carbon | with the gas |
| Example 2 | Chlorine | 1,000 | Activated | Not contacting |
| | | | carbon | with the gas |
| Example 3 | Chlorine | 20,000 | Activated | Not contacting |
| | | | carbon | with the gas |
| Example 4 | Fluorine | 10,000 | Activated | Not contacting |
| | | | carbon | with the gas |
| Example 5 | Hydrogen | 10,000 | Activated | Not contacting |
| | Chloride | | carbon | with the gas |
| Example 6 | Boron | 10,000 | Activated | Not contacting |
| | Trichloride | | carbon | with the gas |
| Example 7 | Dichloro- | 10,000 | Activated | Not contacting |
| | silane | | carbon | with the gas |
| Example 8 | Tungsten | 10,000 | Activated | Not contacting |
| | Hexafluoride | | carbon | with the gas |
| Example 9 | Chlorine | 10,000 | Alumina | Not contacting |
| | | | | with the gas |
| Example 10 | Chlorine | 10,000 | Zeolite | Not contacting |
| | | | | with the gas |
| Example 11 | Chlorine | 10,000 | Vinyl | Contacting with |
| | | | chloride | the gas |
| Comparative | Chlorine | 10,000 | Vinyl | Not contacting |
| Example 1 | | | chloride | with the gas |
| Comparative | Chlorine | 10,000 | Vinyl | Contacting with |
| Example 2 | | | chloride | the gas |

| | Removing Efficiency (%) of the halogen-based gas | | | |
|---|---|---|---|---|
| | First time | 5 times | 10 times | 20 times |
| Example 1 | More than | More than | More than | More than |
| | 99.99 | 99.99 | 99.99 | 99.99 |
| Example 2 | More than | More than | More than | More than |
| | 99.99 | 99.99 | 99.99 | 99.99 |
| Example 3 | More than | More than | More than | More than |
| | 99.99 | 99.99 | 99.99 | 99.99 |
| Example 4 | More than | More than | More than | More than |
| | 99.99 | 99.99 | 99.99 | 99.99 |
| Example 5 | More than | More than | More than | More than |
| | 99.99 | 99.99 | 99.99 | 99.99 |
| Example 6 | More than | More than | More than | More than |
| | 99.99 | 99.99 | 99.99 | 99.99 |
| Example 7 | More than | More than | More than | More than |
| | 99.99 | 99.99 | 99.99 | 99.99 |
| Example 8 | More than | More than | More than | More than |
| | 99.99 | 99.99 | 99.99 | 99.99 |
| Example 9 | 97.8 | 97.6 | 97.6 | 97.4 |
| Example 10 | 98.3 | 98.2 | 98.0 | 98.0 |
| Example 11 | 99.8 | 99.8 | 99.8 | 99.8 |
| Comparative | 15.1 | — | — | — |
| Example 1 | | | | |
| Comparative | 65.1 | — | — | — |
| Example 2 | | | | |

TABLE 2

| | | | Filler at | Filler at |
|---|---|---|---|---|
| | Halogen-based | Concentration | Upstream | Downstream |
| | gas | (ppm) | side | side |
| Example 12 | Chlorine | 10,000 | Vinyl | Activated |
| | | | chloride | carbon |
| | Hydrogen | 10,000 | Vinyl | Activated |
| | Chloride | | chloride | carbon |
| Comparative | Chlorine | 10,000 | Vinyl | Vinyl |
| Example 3 | | | chloride | chloride |
| | Hydrogen | 10,000 | Vinyl | Vinyl |
| | Chloride | | chloride | chloride |

Removing Efficiency (%)

| | Upstream side | Downstream side |
|---|---|---|
| Example 12 | 58.2 | More than 99.99 |
| | 98.6 | More than 99.99 |
| Comparative Example 3 | 58.2 | 64.5 |
| | 98.6 | 99.3 |

### Examples 13 to 18

Processing tests of exhaust gas were carried out in similar manners as Example 1 except that water was replaced to aqueous solutions containing sodium hydroxide (concentration: 2% by weight), calcium hydroxide (concentration: 2% by weight), sodium sulfite (concentration: 5% by weight), sodium thiosulfate (concentration: 20% by weight), sodium carbonate (concentration: 5% by weight) and sodium hydrogen carbonate (concentration: 5% by weight) respectively. The results are shown in Table 3.

TABLE 3

| | Halogen-based | Chemical solution |
|---|---|---|
| | gas | (Concentration (wt %)) |
| Example 13 | Chlorine | Sodium hydroxide (2) |
| Example 14 | Chlorine | Calcium hydroxide (2) |
| Example 15 | Chlorine | Sodium sulfite (5) |
| Example 16 | Chlorine | Sodium thiosulfite (20) |
| Example 17 | Chlorine | Sodium carbonate (5) |
| Example 18 | Chlorine | Sodium hydrogen carbonate (5) |

| | Removing Efficiency (%) of the halogen-based gas | | | |
|---|---|---|---|---|
| | First time | 5 times | 10 times | 20 times |
| Example 13 | More than | More than | More than | More than |
| | 99.99 | 99.99 | 99.99 | 99.99 |
| Example 14 | More than | More than | More than | More than |
| | 99.99 | 99.99 | 99.99 | 99.99 |
| Example 15 | More than | More than | More than | More than |
| | 99.99 | 99.99 | 99.99 | 99.99 |
| Example 16 | More than | More than | More than | More than |
| | 99.99 | 99.99 | 99.99 | 99.99 |
| Example 17 | More than | More than | More than | More than |
| | 99.99 | 99.99 | 99.99 | 99.99 |
| Example 18 | More than | More than | More than | More than |
| | 99.99 | 99.99 | 99.99 | 99.99 |

As described above, it was verified that the processing method of exhaust gas and the processing apparatus of exhaust gas in accordance with the present invention remove the halogen-based gas from the exhaust gas with superior removing efficiency compared with the conventional wet process.

### INDUSTRIAL APPLICABILITY

The processing method of exhaust gas and the processing apparatus of exhaust gas in accordance with the present invention enable to remove the halogen-based gas from the exhaust gas with superior removing efficiency as compared with the conventional wet process without employing alkaline aqueous solution containing chemical agent with high concentration. As a result, the present invention enabled to reduce the running cost inexpensive, and to make the processing apparatus compact.

While there has been shown and described what are at present considered the preferred embodiments of the invention, it will be obvious to those skilled in the art that various changes and modification may be made therein without departing from the scope of the invention defined by the appended claims.

What is claimed is:

1. A processing method of an exhaust gas which comprises a step (A) adding a halogen-based gas-absorbing liquid to an adsorbent and a step (B) bringing the exhaust gas containing a halogen-based gas discharged from semiconductor manufacturing facilities into contact with the adsorbent, to remove the halogen-based gas from the exhaust gas.

2. The processing method of the exhaust gas according to claim 1, wherein said step (A) is conducted at least one selected from before, after or at a timing of said step (B).

3. The processing method of the exhaust gas according to claim 1, wherein said step (B) induces removal of said halide-based gas by adsorption from the exhaust gas.

4. The processing method of the exhaust gas according to claim 1, wherein the halogen-based gas adsorbed to said adsorbent is desorbed from said adsorbent by being absorbed by the halogen-based gas-absorbing liquid in said step (A).

5. The processing method of the exhaust gas according to claim 1 which further comprises a step (C) bringing the exhaust gas containing the halogen-based gas into contact with the halogen-based gas-absorbing liquid under the existence of a filler incapable of adsorption.

6. The processing method of the exhaust gas according to claim 1, wherein said adsorbent is at least one selected from a group consisting of an activated carbon, a zeolite and a porous ceramic.

7. The processing method of the exhaust gas according to claim 1, wherein said halogen-based gas is at least one kind selected from a group consisting of a halogen gas, a hydrogen halide gas, a boron halide gas, a silicon halide gas and a tungsten halide gas.

8. The processing method of the exhaust gas according to claim 1, wherein said halogen-based gas-absorbing liquid is water, an alkaline aqueous solution, an aqueous solution containing salt of alkali metal compound, or an aqueous solution containing salt of alkaline earth metal compound.

9. A processing apparatus of an exhaust gas, which comprises an inlet for the exhaust gas containing a halogen-based gas discharged from semiconductor manufacturing facilities, a filling part of an adsorbent, means for adding a halogen-based gas-absorbing liquid to the filling part and an outlet of the processed gas.

10. The processing apparatus of the exhaust gas according to claim 9, which further comprises a filling part of a filler incapable of adsorption at a passage way of the exhaust gas between said inlet and said filling part of the adsorbent, and still further comprises means for adding the halogen-based gas-absorbing liquid to the filling part of a filler incapable of adsorption.

11. The processing apparatus of the exhaust gas according to claim 9, wherein said means for adding the halogen-based gas-absorbing liquid to the filling part of the adsorbent is a spray nozzle or a shower head nozzle spouting the halogen-based gas-absorbing liquid.
